(19) United States
(12) Patent Application Publication
(10) Pub. No.: US 2023/0328194 A1
(43) Pub. Date: Oct. 12, 2023

(54) BACKGROUND DISPLAY DEVICE

(71) Applicant: Arnold & Richter Cine Technik GmbH & Co. Betriebs KG, Munchen (DE)

(72) Inventor: Hermann POPP, München (DE)

(21) Appl. No.: 18/130,522

(22) Filed: Apr. 4, 2023

(30) Foreign Application Priority Data
Apr. 8, 2022 (DE) 102022108569.4

(51) Int. Cl. H04N 5/222; G03B 15/02

(52) U.S. Cl. CPC H04N 5/2224; G03B 15/02

(57) ABSTRACT

A background display device for a virtual image recording studio comprises at least one panel having a plurality of picture elements, wherein each picture element has a respective light source unit that comprises a first light source, a second light source, and a third light source. The background display device has a control device that is configured to individually control the light sources and to generate a respective light source unit emission spectrum of the light source unit by mixing the respective emission spectra of the light sources. The panel furthermore comprises a plurality of correction light sources and the control device is configured to adapt the respective light source unit emission spectrum to a corrected emission spectrum, which is approximated to a predefined or predefinable emission spectrum, by controlling the correction light sources.

The invention relates to a background display device for a virtual image recording studio that is configured to display, behind or above a real subject, a representation of a virtual background for a recording by an associated camera.

Such background display devices may in particular be provided to display in an image recording studio a landscape or an environment in which a recording is to be made by an associated camera and which forms a virtual background for a scene to be recorded. The image recording studio, for example, may be a film studio for recording moving image sequences or a photo studio in which individual images or still images are recorded. In general, such a recording may include local storage of image data or a transmission to a remote location (e.g. Broadcast, Streaming). In the virtual image recording studio, a virtual background or an environment may thus be created in which an actor may move around during a moving image recording, or it may form a background for a still image recording.

For example, when recording moving images, a background display device may be used to display a representation of a virtual background to be able to record a scene directly in the intended environment. In particular, as a result of this, the acting may be facilitated since possible events occurring in the virtual background may be perceived by an actor and the actor may react to these events. In contrast to the use of a green screen for example where the environment is not visible to the actor, the actor may therefore adapt his acting to any background events and a director, a camera person or any other person involved in a shooting may already gain an overall impression of the scene during the shooting and may evaluate the scene. In addition, the entire scene or a corresponding section of a film may be viewed and checked directly after the recording, without the background provided for the scene also having to be superposed.

In the case of still image recordings, such a background display device may, for example, be used to record photographs in basically any surrounding in an image recording studio, and thus in a controllable environment, and to have the resulting image fully in view while taking the photograph. The background and the real subject or a person to be photographed may thus be optimally matched or coordinated with one another. In addition, the recorded photo may be viewed immediately to be able to carry out necessary adaptations if required.

To display the representation of the virtual background, background display devices may in particular form or have an electronic display, which has an active picture element matrix, and may, for example, comprise an active illumination apparatus having a plurality of light sources and/or active picture elements. For example, to display a representation of a virtual background in a virtual image recording studio, an LED wall may be used whose light-emitting diodes may be controllable individually and/or in groups of adjacent light-emitting diodes or in arrays of light-emitting diodes. Light-emitting diodes of such an LED wall may, for example, be provided as LEDs (light-emitting diodes) or as OLEDs (Organic light-emitting diodes). Furthermore, the light-emitting diodes may be part of a liquid crystal display. Such background display devices may, for example, extend over a width of at least 5 m and a height of at least 2 m to be able to record a plurality of actors in front of a common (virtual) background.

Furthermore, background display devices may comprise a plurality of panels at which the picture elements are arranged and which together form the LED wall. While the panels may be substantially two-dimensional and the picture elements arranged at a panel may extend in a two-dimensional arrangement, it may, for example, be achieved by a suitable arrangement of a plurality of panels that the background display device is sectionally curved and/or arched. The background display device may thereby be arranged, for example, both behind and above the real subject in the virtual image recording studio in order also to enable the direct recording of a representation of a virtual sky or of a virtual ceiling of a room in the image recording studio. Alternatively to an LED wall, a representation of a virtual background may generally also be generated by light spots that are produced by a reflection or a transmission at a light source wall, for example, a screen for a rear projection. For this purpose, the active light generation may take place by a projector, wherein the light sources are merely formed indirectly on the screen.

Such a background display device may in particular make it possible to visually present a virtual background by appropriately controlling the picture elements and/or to adapt said virtual background by changing the control during a recording. The virtual background mentioned in the present context may in particular represent a background subject whose representation may be directly recorded by an associated camera as an apparently real environment of a (foreground) scene. A background display device thus offers the possibility of representing a virtual background for a scene to be recorded in an animated and easily adaptable manner and thereby, in particular, of facilitating the acting or the gestures.

To be able to display different representations of a virtual background at such a background display device, one usually endeavors to configure the background display device to display as large a color space as possible. For this purpose, different light sources that emit light in a respective wavelength range may, for example, be mixed with one another at the picture elements to define a color of a respective picture element. For example, mixing red, green, and blue light sources may make it possible to display a large RGB (red-green-blue) color space at the background display device so that a respective image element of the representation of the virtual background may be displayed at the background display device in particular by mixing respective red, green, and blue light sources of a picture element.

To maximize the color space that may be displayed at the background display device, provision may furthermore be made to use spectrally narrow-band light sources at the background display device that may in particular emit colors disposed very far outside in the visible spectrum. These colors disposed very far outside may thereby in principle also be achievable for a display at the background display device and all the colors between the colors disposed at the outside may generally be displayable by appropriately mixing the individual light sources.

In connection with such background display devices configured to display a large color space, the problem, however, arises that the light spectrum emitted by the background display device may differ from a spectrum of natural light and may, for example, extend discontinuously. However, the light emitted by the background display device is reflected by real subjects, in particular by actors, recorded by the camera in front of or below the representation of the virtual background, wherein these real subjects may have wavelength-dependent reflection properties. Therefore, due to the light of the background display device that is spectrally different from natural light, the light reflected by the real subject may therefore, for example, appear in a different color than on a reflection of natural light and may be imaged accordingly by the camera. In this regard, in the case of such background display devices with a large color space, only an insufficient color reproduction quality may usually be achieved that may result in a complex and/or expensive post-processing of the recorded camera material, in particular in the region of the imaged real subjects. In particular in situations where the real subject is additionally illuminated, for example, by spotlights in the virtual image recording studio that may again have a different emission spectrum and, for example, an emission spectrum optimized for a good color reproduction, such a correction is usually hardly possible, however.

It is therefore an object of the invention to provide a background display device that enables a display of a representation of a virtual background in a large color space and that has an improved color reproduction quality compared to conventional background display devices.

This object is satisfied by a background display device having the features of claim 1.

The background display device has at least one panel having a plurality of picture elements in an at least two-dimensional arrangement, wherein each of the plurality of picture elements has a respective light source unit that comprises a first light source for generating a first emission spectrum, a second light source for generating a second emission spectrum, and a third light source for generating a third emission spectrum. The background display device further has a control device that is configured to individually control the light sources of the light source units and to generate a respective light source unit emission spectrum by mixing the respective first emission spectra, second emission spectra, and third emission spectra. Furthermore, the at least one panel has a plurality of correction light sources and the control device is configured to adapt the respective light source unit emission spectrum to a corrected emission spectrum, which is approximated to a predefined or predefinable emission spectrum, by controlling the correction light sources.

The representation of the virtual background may in particular be assembled from a plurality of pieces of image information, wherein each piece of image information may in particular comprise a color value and a brightness that is displayed at a respective picture element. Since each picture element comprises a light source unit that has three light sources for generating respective emission spectra, image information associated with the picture element may be set at the picture element by means of the control device by a corresponding setting of the intensities and/or brightnesses of the individual light sources so that the image information may be displayed at and by the picture element at the background display device or at the at least one panel. The first emission spectrum, the second emission spectrum, and the third emission spectrum may in particular differ from one another for this purpose so that a specific color value may be settable by a correspondingly proportional mixing of the emission spectra. For example, the light sources of the light source units may be configured to emit a respective narrow-band emission spectrum, wherein furthermore two light sources of the three light sources of a light source unit may in particular be configured to emit light with colors disposed far outside in the visible spectrum to be able to display as large a color space as possible by means of the background display device.

Since each of the picture elements has such a respective light source unit, in particular a large color space may be displayable at the background display device in a resolution predefined primarily by the arrangement of the picture elements. In general, any desired color may be settable at each picture element by appropriately mixing the emission spectra of the three light sources, wherein the settable color space may in particular be defined by the spectrally outermost emission spectra of the first emission spectrum, the second emission spectrum, and the third emission spectrum.

While the light source units thus enable a precise setting of the displayed color of the picture element, the light source unit emission spectrum generated at a specific color may, however, differ from an emission spectrum of natural light due to the intermixing of only three emission spectra, and in particular three narrow-band emission spectra, and may extend discontinuously, for example. However, to also be able to achieve as high as possible a color reproduction quality by means of the background display device, a large number of correction light sources are furthermore arranged at the panel and may be controlled by means of the control device.

These correction light sources make it possible, as a result of a control by the control device and in particular by a mixing of emission spectra of the correction light sources, which may also be referred to as correction light emission spectra, with the light source unit emission spectra, to adapt the light source unit emission spectra such that the corrected emission spectrum ultimately emitted by a light source unit is approximated to the predefined or predefinable emission spectrum. Due to the additional emission of light by the correction light sources, the corrected emission spectrum may in particular be stabilized with respect to the light source unit emission spectrum and may thereby be approximated to an emission spectrum of natural light in that the emission spectra of the correction light sources may so-to-say bridge gaps disposed in a light source unit emission spectrum between the respective emission spectra of the individual light sources. For this purpose, the correction light sources may in particular be configured to emit light with an emission spectrum that differs from the first emission spectrum, the second emission spectrum, and the third emission spectrum.

Such a correction of the light source unit emission spectrum may in particular make it possible to be able to image real subjects arranged in front of or below the representation of the virtual background or the background display device by the associated camera in an environment resembling natural light by means of the associated camera, for which purpose an emission spectrum of natural light may be provided as the predefined or predefinable emission spectrum. The impression of a scene recorded in the virtual image recording studio that is created in the image may thereby be even further approximated to the impression of a recording in a real background corresponding to the virtual background, for example, a landscape in natural light. Furthermore, such a corrected emission spectrum may be approximated to an illumination emission spectrum of any further illumination apparatus in the virtual image recording studio, for example of a spotlight, that may be adapted for as high as possible a display quality so that the illumination emission spectrum of the illumination apparatus may form the predefined or predefinable emission spectrum. Any transitions in an image of the real subject generated by the camera due to the spectral reflection properties of the real subject, which may lead to a different color impression in the image in a transition from an illumination by a spotlight to an illumination by the background display device, may thus be avoided. Accordingly, the effort with respect to a subsequent processing of the image generated by the camera to compensate for such effects may also be minimized by adapting the light source unit emission spectrum to a corrected emission spectrum and by increasing the color reproduction quality of the background display device.

Provision may generally be made that the control device is configured to approximate the corrected emission spectrum to a predefined emission spectrum, for which purpose such a predefined emission spectrum may, for example, be stored in a memory of the background display device. For example, an emission spectrum of natural white light may form the predefined emission spectrum so that the control device may be configured to approximate the corrected emission spectrum to the emission spectrum of natural light. However, different predefined emission spectra may also be stored, for example emission spectra of natural light of different color temperatures, wherein the control device may be configured to approximate the corrected emission spectrum to a natural emission spectrum whose color temperature corresponds to the color temperature of the respective light source unit emission spectrum. Furthermore, an illumination emission spectrum of an illumination apparatus may, for example, be stored as a predefined emission spectrum in a memory so that the corrected emission spectrum may be approximated to such a predefined illumination emission spectrum.

Alternatively thereto, the emission spectrum to which the corrected emission spectrum is to be approximated may, however, also be predefinable, for which purpose a user may, for example, enter basically any desired emission spectra at an input device and transmit them to the control device. Furthermore, provision may be made that the emission spectrum may be predefinable by further devices, in particular an illumination apparatus or a measurement device for measuring an illumination emission spectrum of an illumination apparatus, in that the respective emission spectrum or information about it may be transmittable to the control device by the corresponding device. The background display device may in particular have a signal input to be able to receive corresponding information.

Further embodiments can be seen from the dependent claims, the description, and the drawings.

In some embodiments, the background display device may be configured as an LED wall and the picture elements may be configured as light-emitting diode units. The light sources and/or the correction light sources may further be configured as light-emitting diodes. Furthermore, the light source units may in particular be configured as light-emitting diode units.

The light-emitting diodes of such an LED wall may, for example, be configured as LEDs (light-emitting diodes) or as organic light-emitting diodes or OLEDs (Organic light-emitting diodes). Furthermore, in the case of an LED wall, provision may generally be made that the individual picture elements, which together generate the representation of the virtual background, are formed by individual light-emitting diodes. However, the individual picture elements may also be formed by respective light-emitting diode units, wherein each light-emitting diode unit may comprise a plurality of light-emitting diodes, in particular three light-emitting diodes, as light sources. For example, a light-emitting diode unit may also comprise three, four, or more light-emitting diodes, wherein the plurality of light-emitting diodes of a light-emitting diode unit may in particular have different emission spectra and may optionally be equipped with a color mixer. Furthermore, in such a light-emitting diode unit, provision may be made that the individual light-emitting diodes of the light-emitting diode unit may be selectively controlled to generate a desired color of the picture element formed by the light-emitting diode unit. A light-emitting diode unit may in particular comprise a light-emitting diode emitting red light, a light-emitting diode emitting green light, and a light-emitting diode emitting blue light.

Furthermore, in some embodiments, the correction light sources may be configured as light-emitting diodes. The correction light sources may also in particular be configured to emit light with a narrow-band correction light emission spectrum, wherein a widened and/or stabilized corrected emission spectrum of the light source unit may be producible by appropriately mixing the light sources of a light source unit and in particular a plurality of correction light sources. Correction light sources configured as light-emitting diodes may in particular be configured to emit light with a color different from the light emitted by the light sources to be able to correct the light source unit emission spectrum.

In some embodiments, provision may further be made that the picture elements may be individually controlled to generate the representation of the virtual background. By controlling the picture elements, a respective color and/or brightness of the picture element may in particular be settable to be able to set a section or a point of the representation of the virtual background that is displayed by the respective picture element to the intended color and/or brightness.

In some embodiments, the background display device may extend in a vertical and/or horizontal orientation. For example, provision may be made that the background display device extends in a vertical orientation in a planar manner behind the real subject to display the representation of the virtual background behind the real subject. Alternatively or additionally, provision may, however, also be made that the background display device at least sectionally extends in a horizontal orientation so that the representation of the virtual background may also be displayed above the real subject, for example. Furthermore, the background display device may be configured to surround and to cover the real subject in order to enable as complete as possible a display of the virtual background over a large angular range. In a section in which the background display device transitions from a vertical orientation into a horizontal orientation, the background display device may also be arched and/or curved. In particular in an assembly of the background display device from a plurality of panels, the panels may be assembled to form different and, for example, vault-like geometries in order to provide a desired environment for a recording in the virtual image recording studio.

The background display device may be arched in some embodiments. The background display device may thereby be arranged surrounding, for example, an actor in the virtual image recording studio so that the representation of the virtual background may in particular be imaged by the associated camera at as many camera alignments or recording angles as possible if the camera images the actor from different directions, for example. The background display device may in particular be configured to surround the real subject and in particular an actor such that the representation of the virtual background and the real subject may be imagable together over a recording angle range of at least 180 degrees. For this purpose, the background display device may in particular be arranged extending in a circular arc shape around the real subject in a vertical orientation in the virtual image recording studio.

Furthermore, in some embodiments, the background display device may extend over a width of at least 5 m and a height of at least 2 m. The background display device may thereby in particular have a sufficient size to be able to record several actors in front of a common (virtual) background. Furthermore, such a sufficient size of the background display device may, for example, make it possible to position various real objects, such as furniture and/or seating, in the virtual image recording studio and, for example, to record a film scene involving these real objects and/or with moving actors in front of the representation of the virtual background. The representation of the virtual background and/or the background display device may in particular extend beyond a section imaged by the camera during a typical recording in the virtual image recording studio, in particular a recording of a scene performed by actors, so that the representation of the virtual background may, for example, extend in the image generated by the camera up to all the edges of the image and is not limited to an inner section of the image.

In some embodiments, the background display device may further be configured to illuminate the real subject. This background display device may in particular serve to illuminate the real subject in addition to other illumination of the virtual image recording studio. For example, it may thereby be achieved that the real subject casts a shadow to be expected when illumination sources, for example a street lamp, are included in the virtual background in that the illumination of the real subject to be expected from a real street lamp starts from the displayed representation of the street lamp of the virtual background. However, the background display device may also be configured to sectionally emit light for illuminating a scene and may so-to-say act as a spotlight, while the background display device may display the representation of the virtual background at other sections. In particular with regard to such an illumination of the real subject, an increased color reproduction quality of the background display device that is achievable by the correction light sources may expand the possibilities of use of said background display device.

In some embodiments, the virtual background may represent a three-dimensional scene. For example, the virtual background may be a landscape or a room in which a scene to be recorded in the virtual image recording studio is set. The representation of the virtual background displayed at the background display device and/or a section of the representation of the virtual background displayed at the at least one panel may in particular correspond to a projection of the three-dimensional scene or of a section of the three-dimensional scene onto the two-dimensional arrangement of the picture elements.

In some embodiments, the background display device may be configured to vary the representation of the virtual background in time during the recording. Events taking place in the virtual background may thereby in particular be displayed directly by the background display device during a camera recording so that, unlike, for example, in the case of a green screen recording, an actor may react to these events and may correspondingly adapt the acting thereto. Consequently, the background display device may in particular be configured to display a film sequence, which may be recorded directly by the camera, during the camera recording. A subsequent superposition of the recording of the camera with a provided background is thus no longer necessary.

In some embodiments, the control device may be configured to adapt the light source unit emission spectrum such that a maximum of the corrected emission spectrum corresponds to a maximum of the light source unit emission spectrum. Alternatively or additionally, in some embodiments, the control device may be configured such that a wavelength associated with a maximum of the corrected emission spectrum corresponds to a wavelength associated with a maximum of the light source unit emission spectrum.

The control device may in particular be configured to adapt the light source unit emission spectrum such that the corrected emission spectrum is approximated to an emission spectrum of natural light having the color temperature defined by the light source unit emission spectrum. For this purpose, a wavelength at which the corrected emission spectrum reaches a maximum may in particular correspond to a wavelength at which the light source unit emission spectrum reaches a maximum. Consequently, the control device may be configured to adapt the light source unit emission spectrum such that the predefined color and/or the color associated with the light source unit emission spectrum continues to be displayed at the respective picture element, wherein the corrected emission spectrum emitted by the picture element may, however, be approximated to a spectrum which an image element represented by the picture element irradiates in a real background which corresponds to the virtual background and in which natural light is ultimately reflected by the image element. This may in particular make it possible to display a representation of generally any desired virtual background, for example a landscape, by means of the background display device in that colors from a large color space may be displayed at the background display device. Furthermore, the light emitted by the background display device or the picture elements may, however, be reflected on a reflection by a real subject in the image recording studio in such a way as would be expected on an illumination by natural light and thus in a real background corresponding to the virtual background, i.e., for example, in the real landscape. Overall, a natural impression of a scene recorded in the virtual image recording studio as well as a high color reproduction quality may thereby be achieved, whereby possibly necessary post-processing may be reduced.

Since the control device may furthermore be configured to adapt the light source unit emission spectrum such that a maximum of the corrected emission spectrum corresponds to a maximum of the light source unit emission spectrum, a brightness of the light emitted by the picture element may in particular also be unchanged or at least, if necessary, slightly changed by adapting the light source unit emission spectrum. Thus, the image information displayed at the picture element may in particular remain substantially unchanged by adapting the light source unit emission spectrum so that the displayed representation of the virtual background may remain substantially unchanged for an observer by adapting the light source unit emission spectrum.

In some embodiments, the first light source may be configured to emit red light, the second light source may be configured to emit green light, and the third light source may be configured to emit blue light. The light source units may thus in particular form respective red-green-blue (RGB) units, wherein a large (RGB) color space may be imaged by an additive mixing of these three primary colors and may be displayed at the background display device or at the at least one panel. Such RGB units may in particular also be provided in already existing background display devices so that such background display devices may, for example, be retrofitted by attaching correction light sources and by appropriately adapting the control devices to improve the color reproduction quality in the sense of the present disclosure. A complete new design of background display devices or their panels to achieve an improved color reproduction quality is therefore not absolutely necessary.

In some embodiments, the first emission spectrum, the second emission spectrum, and the third emission spectrum may form narrow-band emission spectra around a respective emission maximum.

For example, these emission maxima, at least the emission maxima of two emission spectra of the three emission spectra, may be disposed very far outside in the visible light spectrum to be able to display as large a color space as possible by means of the light source units. The emission spectra may in particular be generated by respective light-emitting diodes as which the light sources may be configured and which may be suitable for the emission of narrow-band emission spectra. The first emission spectrum, the second emission spectrum, and the third emission spectrum may in particular emit approximately unicolored light. The first emission spectrum, the second emission spectrum, and the third emission spectrum may in this regard differ from an emission spectrum of natural light, in particular in the color generated by the first light source, the second light source, and the third light source.

In some embodiments, the control device may be configured to approximate the light source unit emission spectra to a blackbody spectrum by controlling the correction light sources. In particular, the control device may thus be configured, by mixing the first emission spectrum, the second emission spectrum, and the third emission spectrum of the light sources of a light source unit with the emission spectra of the correction light sources, to so-to-say link the respective emission spectra of the light sources and to bridge gaps in the light source unit emission spectrum in order to approximate the corrected emission spectrum of the light source unit to a continuous blackbody spectrum of natural light. In particular, the control device may therefore be configured to stabilize the light source unit emission spectrum by controlling the correction light sources in order, for example, to compensate for jumps between the individual maxima of the first emission spectrum, the second emission spectrum, and the third emission spectrum in the light source unit emission spectrum.

Since, in some embodiments, the color space that may be generated by the background display device may extend beyond a color space that may be generated by blackbody radiation, such an approximation to a blackbody spectrum and/or the emission spectrum of natural light may thus in particular take place by stabilizing the light source unit emission spectrum, widening the light source unit emission spectrum, and/or generating a more continuous corrected emission spectrum. Furthermore, provision may be made that the control device is configured to place the light source unit emission spectrum beneath a blackbody spectrum that is as close as possible to the color generated by the light source unit by controlling the correction light sources so that this blackbody spectrum may at least influence the reflection of the light emitted by the background display device or a picture element by the real subject and may approximate a reflection under natural light conditions.

In some embodiments, the control device may further be configured to approximate the light source unit emission spectra, by controlling the correction light sources, to a blackbody spectrum whose maximum corresponds to a maximum of the respective light source unit emission spectrum. Furthermore, the control device may be configured to approximate the light source unit emission spectra, by controlling the correction light sources, to a blackbody spectrum whose maximum lies at a wavelength at which the light source unit emission spectrum also reaches its maximum. In particular if the color generated by the light source unit corresponds to a color that may be generated by blackbody radiation, the control device may thus be configured to adapt the light source unit emission spectrum to the corresponding blackbody spectrum, but without changing the color and/or brightness emitted by the picture element. The representation of the virtual background may thus in particular be displayed substantially unchanged, wherein the color reproduction quality may, however, be improved by such an adaptation of the light source unit emission spectrum.

In some embodiments, the control device may be configured to adapt intensities and/or brightnesses of the respective first light source, second light source, and third light source in order to generate a light source unit emission spectrum.

A contribution of the associated first emission spectrum, second emission spectrum, and third emission spectrum to the light source unit emission spectrum may in particular be defined by the respective intensity and/or brightness of the light sources in order thereby to generate a color emitted by the respective picture element in the color space defined by the light source units. In this regard, the control device may in particular be configured to individually define and/or set a respective intensity and/or brightness for the first light source, the second light source, and the third light source of a light source unit.

In some embodiments, the first control device may further be configured to adapt the light source unit emission spectrum by adapting an intensity and/or a brightness of the correction light sources. In particular, a respective contribution of an emission spectrum of a correction light source to the corrected emission spectrum of the light source unit may also ultimately be determined by adapting an intensity and/or a brightness of the correction light sources.

In some embodiments, each of the light source units may be associated with at least one respective correction light source. In such embodiments, the control device may in particular be configured to individually adapt the light source unit emission spectrum of each light source unit by controlling the respective correction light source in order to approximate the light source unit emission spectrum to a predefined or predefinable emission spectrum. At each picture element, the emission spectrum emitted by the picture element may therefore in particular be individually adaptable by controlling the correction light sources to be able to emit an emission spectrum approximated to the predefined or predefinable emission spectrum from each picture element.

Furthermore, in some embodiments, each of the light source units may be associated with a plurality of correction light sources, wherein each of the plurality of correction light sources may be configured to generate a respective correction light emission spectrum. The plurality of correction light sources may in particular be configured to generate respective correction light emission spectra that differ from one another.

Due to such an association of a plurality of correction light sources with a respective light source unit, the possibilities for influencing the light source unit emission spectrum may in particular be expanded. For example, provision may be made to associate each of the plurality of light source units with at least one correction light source having an emission spectrum whose maximum is reached at a wavelength that lies between the wavelength of the maximum of the first emission spectrum and the wavelength of the maximum of the second emission spectrum. Furthermore, each light source unit may be associated with at least one correction light source that has an emission spectrum having a maximum at a wavelength between respective wavelengths at which the second emission spectrum and the third emission spectrum reach their respective maximum. Due to such an arrangement of correction light sources at the light source units, the light source unit emission spectrum may be influenceable by appropriately controlling the correction light sources, in particular both between the first emission spectrum and the second emission spectrum or their maxima and between the second emission spectrum and the third emission spectrum or their maxima, in order to enable an approximation to the predefined or predefinable emission spectrum and in particular the emission spectrum of natural light and/or to stabilize the light source unit emission spectrum.

In some embodiments, the control device may be configured to determine setting instructions for the control of the correction light sources in dependence on the control of the light source units. For example, the control device may be configured to determine respective setting instructions for the control of the correction light sources in dependence on a color which is to be produced at a respective picture element and which may ultimately be generated by controlling the light source units and mixing their emission spectra in order to approximate the light source unit emission spectrum generated by the light source unit to an emission spectrum of natural light for the set color, for example.

In some embodiments, the control device may be connected to a memory and may be configured to look up the setting instructions in a look-up table stored in the memory in dependence on the control of the light source units. For example, information about how the correction light sources are to be controlled in dependence on a color value or a color temperature set at the light source unit or the picture element may be specified in such a look-up table. Such controls may in particular be determined by a prior calibration of the light source units and/or the correction light sources. The control of the correction light sources may in particular take place quickly through such an access to a look-up table in that the setting instructions for the correction light sources may be directly defined and retrievable by the image information for a respective picture element that is transmitted to the control device and that may comprise the color and/or brightness to be displayed at the respective picture element for displaying the representation of the virtual background.

In some embodiments, the control device may further be configured to determine the light source unit emission spectra in dependence on the control of the respective light sources and/or to determine the corrected emission spectrum in dependence on the control of the correction light sources.

For example, the control device may be configured to determine the light source unit emission spectra in dependence on respective set intensities and/or brightnesses of the first light source, the second light source, and the third light source. For this purpose, the respective first emission spectra, second emission spectra, and third emission spectra may in particular be stored in a memory connected to the control device so that the control device may, for respective settings or controls of the individual light sources, determine contributions of the emission spectra of said individual light sources to the light source unit emission spectrum and may determine the light source unit emission spectrum by combining the individual contributions. Equally, the control device may be configured, by reading out a memory, to access the emission spectra of the correction light sources and to determine the correction light emission spectra in dependence on a control of the correction light sources, in particular a set intensity and/or brightness. The control device may in particular be configured to calculate the emission spectra of the light sources and/or the correction light sources.

In some embodiments, the control device may be connected to a memory in which the first emission spectrum, the second emission spectrum, and the third emission spectrum and/or emission spectra of the correction light sources are stored.

For example, the respective emission spectra may be stored as histograms in the memory, wherein, alternatively or additionally thereto, parameters and/or calculation instructions for determining curves that describe the respective emission spectrum may also be stored in the memory. One of these parameters may in particular be a brightness and/or an intensity of the respective light source or correction light source to enable a determination of the respective emission spectrum in dependence on such a setting or control of the light source or correction light source. The control device may thus be provided with information by means of the memory that enables the determination of the light source unit emission spectrum as a mixture of the emission spectra of the light sources and/or the determination of the corrected emission spectrum in the case of an additional mixing of the emission spectra of the correction light sources to the light source unit emission spectrum.

In some embodiments, the control device may be configured to determine the corrected emission spectrum by superposing the emission spectra of the light sources and the correction light sources. For this purpose, the control device may in particular access respective emission spectra stored in the aforementioned memory, in particular a semiconductor memory, in order to determine a contribution of a respective emission spectrum, for example, based on a brightness and/or an intensity of the respective light source and/or correction light source. By superposing the individual emission spectra or contributions determined in such a manner, the corrected emission spectrum emitted during a specific control of the correction light sources and/or the light sources may then ultimately be determinable by means of the control device.

In some embodiments, the control device may be configured to determine the setting instructions by an approximation method. The control device may in particular be configured to compare a specific corrected emission spectrum, for example by superposing the emission spectra of the light sources of the light source unit and the correction light sources, with the predefined or predefinable emission spectrum and in particular with the emission spectrum of natural light at a specific color in order to increasingly approximate the (determined and/or calculated) corrected emission spectrum to the emission spectrum of natural light by adapting the control of the correction light sources. In this regard, the setting instructions for the control of the correction light sources may in particular be determined by those setting instructions in which the corrected emission spectrum comes closest to the predefined or predefinable emission spectrum. For this purpose, the predefined or predefinable emission spectrum may in particular also be stored in a memory or writable to a memory which the control device may access. Again, for this purpose, the predefined or predefinable emission spectrum may, for example, be stored as a histogram in the memory, wherein provision may also be made that parameters of curves that describe the predefined or predefinable emission spectrum are stored in such a memory. One of these parameters may in particular be a specific color value that may, for example, correspond to a color displayed by the picture element by controlling the first light source, second light source, and third light source. However, different predefined or predefinable emission spectra for different color values may also be stored in the memory.

In some embodiments, the control device may be configured to compare a corrected emission spectrum to be expected in the case of respective setting instructions with the predefined or predefinable emission spectrum and to determine a deviation between the corrected emission spectrum to be expected and the predefined or predefinable emission spectrum. The control device may further be configured to determine the setting instructions by minimizing the deviation. For example, the control device may be configured to determine a mean square deviation between the expected corrected emission spectrum and the predefined or predefinable emission spectrum in order to determine the setting instructions for the correction light sources by minimizing the mean square deviation. The control device may also be configured to determine the setting instructions by a chi-square test. In particular, as already mentioned, the control device may for this purpose be connected to a memory in which information on the emission spectra of the light sources and/or the correction light sources as well as on the predefined or predefinable emission spectrum, in particular on respective emission spectra of natural light at different color values, may be stored.

In some embodiments, the background display device may have a signal input for receiving information about an illumination emission spectrum generated by an illumination apparatus of the virtual image recording studio, in particular a spotlight, wherein the control device may be configured to approximate the corrected emission spectrum to the illumination emission spectrum. The illumination emission spectrum may thus form the predefined or predefinable emission spectrum so that the control device may be configured to match the emission spectrum of the background display device to the illumination of the virtual image recording studio. Due to this approximation of the corrected emission spectrum to the illumination emission spectrum, any color differences in an image generated by the camera of the real subject illuminated by both the background display device and the illumination apparatus may in particular be avoided due to the spectral reflection properties of said real subject.

The signal input may, for example, be configured to receive, from the illumination apparatus, information and/or metadata based on which the illumination emission spectrum may be determined or which represent the illumination emission spectrum. Said information and/or metadata may in particular be parameters of settings of a spotlight, for example, of a color setting of the emitted light or of a brightness setting. Furthermore, provision may be made that the signal input may be connected to a measurement device that is configured to determine the illumination emission spectrum.

In particular, the signal input may further be configured to continuously receive information about the illumination emission spectrum during a recording and to provide said information to the control device, wherein the control device may be configured to always control the correction light sources such that the corrected emission spectrum is approximated to the current illumination emission spectrum. This may in particular make it possible to react to an illumination possibly changing during a recording and to control the correction light sources accordingly.

In some embodiments, the light source units and/or the light sources may be arranged in a regular grid, wherein the correction light sources may be arranged between a plurality of the light source units and/or light sources of the regular grid. Alternatively thereto, provision may also be made that the correction light sources are arranged in place of a respective light source of the regular grid.

Such an insertion of the correction light sources into the regular grid may in particular make it possible to insert the correction light sources into already existing background display devices. For example, in a background display device, a respective light source unit may be assigned an area at the at least one panel that is not completely occupied by the first light source, the second light source, and the third light source so that there may still be a sufficient free area for attaching one or more correction light sources in an area assigned to the light source unit. Such background display devices may thus, for example, be retrofitted with such correction light sources without the requirement for a fundamental restructuring to be able to achieve an improvement in the color reproduction quality by appropriately adapting the control device. For this purpose, the correction light sources may, for example, also be smaller than the light sources. However, provision may also be made to arrange the correction light sources in place of a respective light source in the regular grid so that respective light source units may, for example, be displaced with respect to a conventional arrangement after the attachment of the correction light sources.

In some embodiments, the background display device may comprise a plurality of panels, wherein each of the plurality of panels may be formed as rectangular and in particular as square. Furthermore, each of the plurality of panels and in particular also the at least one panel may be formed without margins. The plurality of panels may furthermore be arranged in an at least two-dimensional matrix. Thus, the background display device may in particular be assembled by a plurality of panels that have a respective plurality of picture elements. Since these panels may be formed without margins, it may in particular be achieved that the representation of the virtual background may also be displayed without interruption at a transition between different panels.

The invention further relates to a background display system comprising a background display device of the kind disclosed herein and an illumination apparatus, in particular a spotlight, that is configured to generate an illumination emission spectrum for illuminating the real subject in the virtual image recording studio. The background display device further has a signal input for receiving information about the illumination emission spectrum and the control device is configured to approximate the corrected emission spectrum to the illumination emission spectrum.

In such a background display system, the emission spectrum generated by the background display device may thus be approximated to the illumination emission spectrum so that reflections by the real subject, which may be irradiated and thereby illuminated by both the illumination apparatus and the background display device, always take place in the same way. Any color shifts in an image generated by a camera, in dependence on whether the real subject is illuminated by the illumination apparatus or by the background display device, may thereby be avoided.

In some embodiments, the signal input may be connected to a measurement device for measuring the illumination emission spectrum. Alternatively or additionally, in some embodiments, the signal input may be connected to the illumination apparatus and the illumination apparatus may be configured to transmit the information about the illumination emission spectrum to the signal input. The control device may in particular be configured to always approximate the corrected emission spectrum to a current illumination emission spectrum to be able to react to an illumination changing during a recording.

The invention further relates to a method of recording a real subject in front of a virtual background in a virtual image recording studio. In these methods, a representation of the virtual background is displayed at a background display device of the kind disclosed herein, the real subject is placed in front of the background display device, and the real subject is recorded in front of the representation of the virtual background by a camera. In the method, the light source unit emission spectrum may in particular be adapted to a corrected emission spectrum that is approximated to a predefined or predefinable emission spectrum, in particular an emission spectrum of natural light or an illumination emission spectrum of an illumination apparatus of the virtual image recording studio.

The background display device may in particular have a width of at least 5 m and a height of at least 2 m for this purpose so that, for example, one actor or several actors, in particular also moving actors, may be imaged in front of the representation of the virtual background by means of an associated camera without an imaging window of the camera, which determines the region imaged by the camera, extending beyond the background display device. The background display device may thus have a size that enables the imaging of the real subject, in particular one actor or several actors, in a virtual environment represented by the virtual background, for example, a landscape or a room.

The invention will be explained in the following purely by way of example with reference to an embodiment and to the drawings.

There are shown:

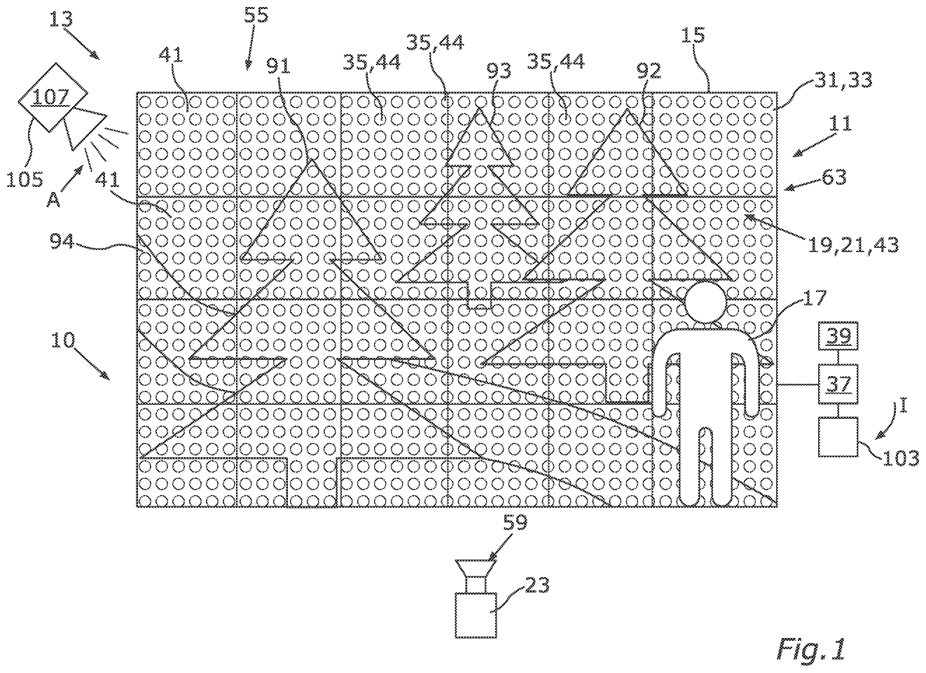

FIG. 1 a schematic representation of a recording system for an image recording studio with a background display device for displaying a representation of a virtual background and with a camera;

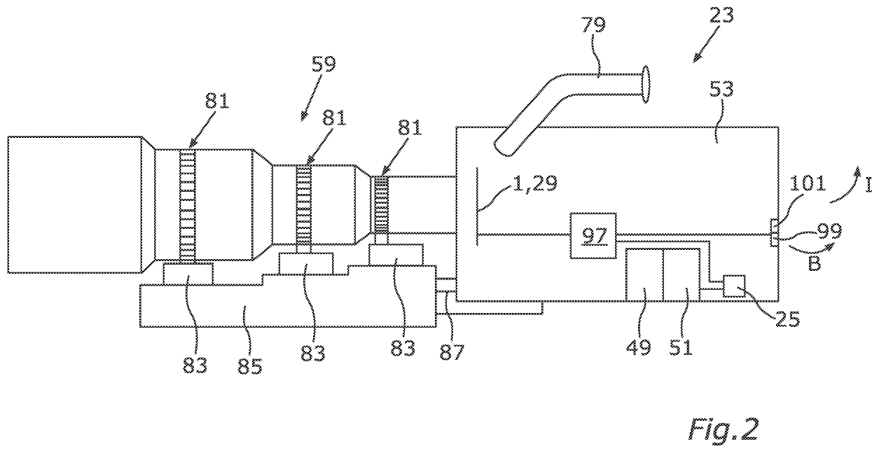

FIG. 2 a schematic representation of a camera provided for a recording in the image recording studio;

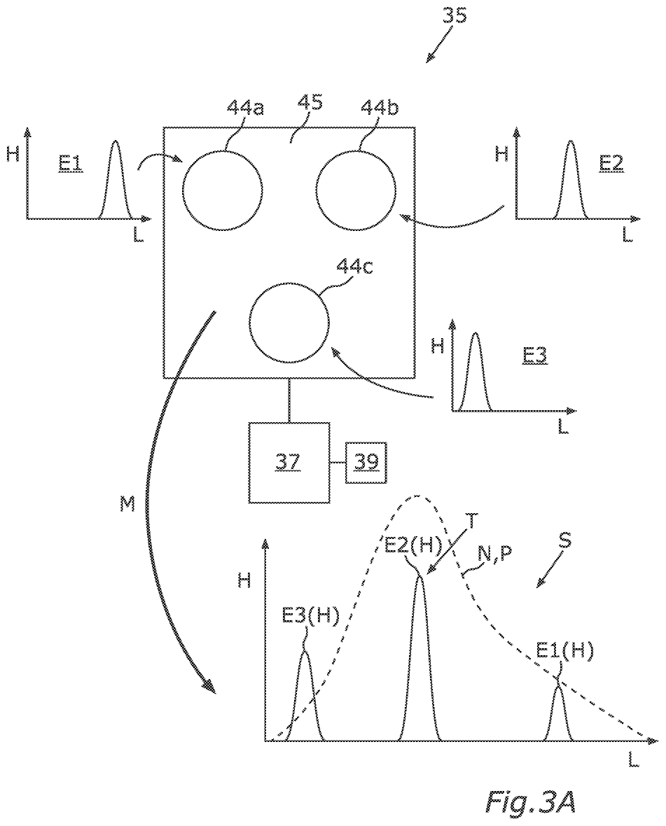

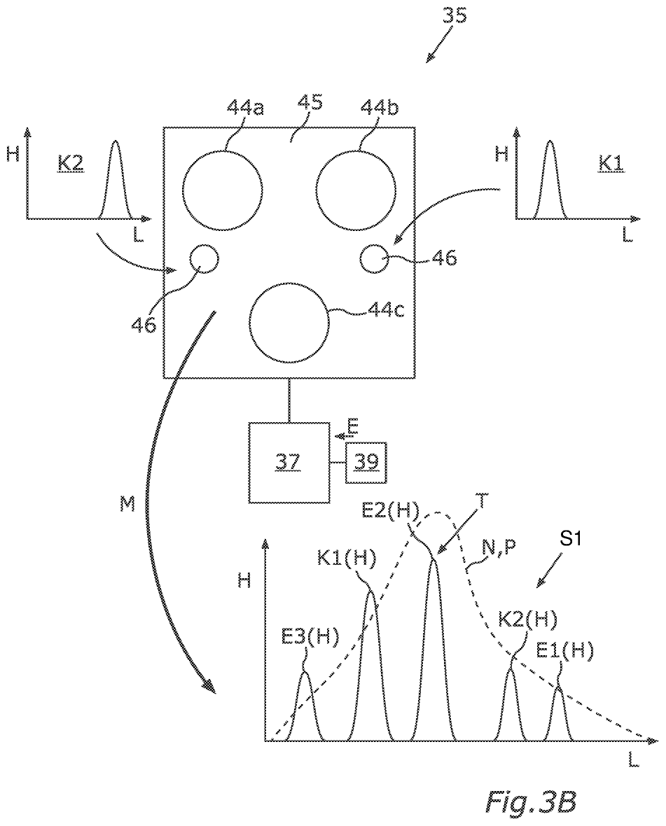

FIGS. 3A and 3B a respective schematic representation of a light source unit of the background display device for illustrating the control thereof during a display of the representation of the virtual background; and

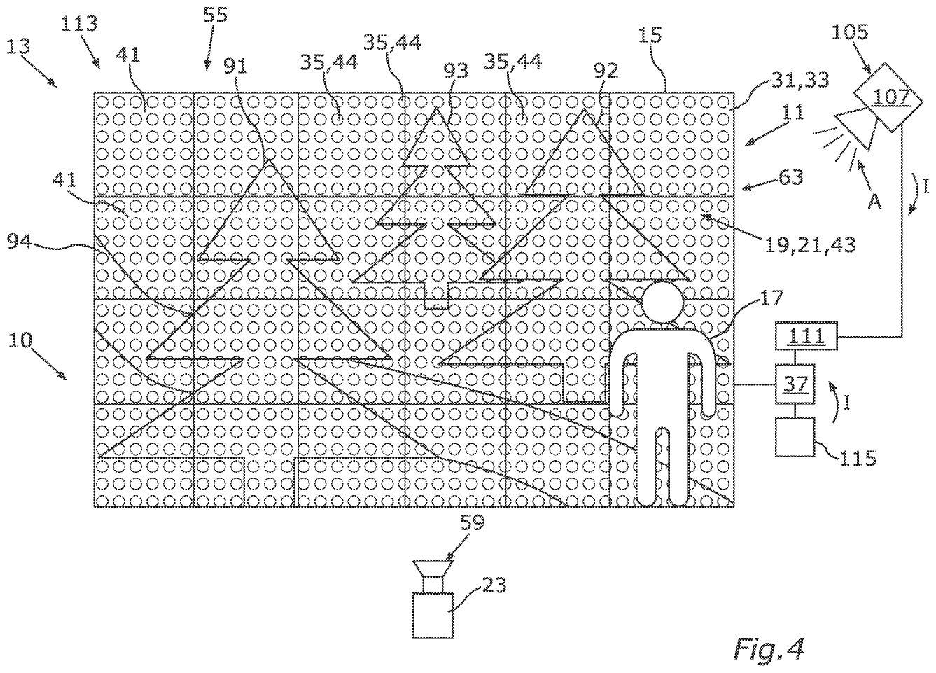

FIG. 4 a further schematic representation of a recording system for an image recording studio with a background display system that comprises a background display device for displaying a representation of a virtual background and an illumination apparatus.

FIG. 1 schematically shows a virtual image recording studio 13, in which a scene, in particular in the form of a moving image recording and/or a photo recording, may be recorded by an associated camera 23. The camera 23 may, for example, be designed as a moving image camera in order to be able to carry out moving images recordings that may be stored as a series of images generated by the camera 23. For this purpose, the camera 23 has a lens 59 (also referred to as an objective) that may in particular be designed as an interchangeable lens (also referred to as an interchangeable objective) and that may selectively be connected to a housing of the camera 23. As a result, a respective lens 59, optimally adapted to the environment in the image recording studio 13, may always be used to be able to generate the best possible recordings. An image sensor 1 comprising a plurality of light-sensitive sensor elements may in particular be arranged in the housing of the camera 23, onto which sensor elements light, which enters via a diaphragm aperture of a diaphragm (also referred to as an aperture stop), may be guided by a lens system or at least one lens to generate an image (cf. also FIG. 2).

Furthermore, a background display system 11 having a background display device is arranged in the image recording studio 13 and, together with the camera 23, forms a recording system 10. The background display device 15 comprises an active illumination apparatus 31 that is in particular configured as an LED wall 31 to display a representation 19 of a virtual background 21 for a recording by the camera 23. For this purpose, the illumination apparatus 31 or the LED wall 33 has a plurality of actively illuminating picture elements 35 that are arranged next to one another in a two-dimensional arrangement and in a regular grid 55.

For example, in such a background display device 15, the picture elements 35 may be configured as individually controllable light sources, but in particular as individually controllable light source units 45, wherein each light source unit 45 of this kind may comprise a plurality of light sources 44a, 44b, and 44c, in particular three light sources 44a, 44b, and 44c (cf. also FIGS. 3A and 3B). Such a light source unit 45 may furthermore comprise a color mixer to be able to set a respective color and/or brightness emitted by the picture element 35 by a respective individual control of the light sources 44a, 44b, and 44c of the light source unit 45, as will be explained in more detail below. The light sources 44a, 44b, and 44c may in particular be configured as LEDs or as organic light-emitting diodes or OLEDs. Background display devices for displaying a representation of a virtual background that generate the representation by a rear projection may generally also be used in the image recording studio 13.

The background display device 15 further comprises a plurality of panels 41. A respective plurality of the actively illuminating picture elements 35 are arranged at each panel 41 of the plurality of panels 41 so that a section of the representation 19 of the virtual background 21 may be displayed at each of the panels 41. The panels 41 are in particular rectangular and/or square and formed without margins so that the representation 19 of the virtual background 21 may also be displayed without visible interruptions at the transitions between panels 41. The panels 41 are further arranged in a two-dimensional matrix to form the background display device 15. In this regard, the active illumination apparatus 31 comprises a plurality of panels 41 in the embodiment shown.

The representation 19 of the virtual background 21 here reflects, for example, a three-dimensional scene 43 with objects 91, 92, 93 and 94, three trees and a path, which may be generated by an appropriate control of the picture elements 35, in particular by an appropriate setting of their respective color and brightness. The three-dimensional scene 43 is projected onto the essentially two-dimensional arrangement of the picture elements 35 of the illumination apparatus 31, wherein in particular the objects 91, 92, and 93 appear at a different distance from the illumination apparatus 31 or the background display device 11 in order to reproduce the three-dimensionality of a real background corresponding to the virtual background 21.

The background display device 15 in particular serves to generate a background for a recording of a real subject 17, for example an actor, in front of which a recording may take place or a film scene may be played. As a result, basically any kind of landscapes, spaces or environments may be created in the image recording studio 13, in front of, or, in which, a scene, for example, for a movie, is to be filmed. To make this possible, the background display device 15 may in particular have a width of at least 5 meters and a height of at least 2 meters. It is furthermore possible, by a time-variable control of the picture elements 35, to show movements in the virtual background 21, for example a passing car, to which the actor 17 may react in an easy and improved manner compared to acting in front of a green screen. The virtual background 21 or its representation 19 may thus be directly imaged by the camera 23 during a recording in the virtual image recording studio so that a virtual background 21, as in the case of a green screen recording, does not have to be subsequently added to the image generated by the camera 23.

The background display device 15 extends here essentially in the vertical direction so that the actor 17 may move in front of the virtual background 21. However, in order to be able to depict the virtual background 21 more extensively, the background display device 15 may also extend around or above the actor 17, wherein the background display device 15 may in particular have a horizontal orientation above the actor 17. To be able to surround the actor 17 or to produce a transition from the vertical orientation shown to a horizontal orientation, the background display device 15 or the illumination apparatus 31 or the LED wall 33 may also be at least sectionally arched or curved.

In addition to representing the virtual background 21, the background display device 15 may also serve to illuminate the real subject 17. The background display device 15 may thereby, for example, support an illumination apparatus 105, in particular a spotlight 107, that generates light with an illumination emission spectrum A in order to illuminate the real subject 17. Furthermore, by illuminating the real subject 17 by the background display device 15, the interaction of the real subject 17 or the actor 17 with light sources present in the virtual background 21, for example, lanterns or lamps, may be improved in that the real subject 17 casts a shadow that corresponds to the light conditions visible in an image generated by the camera 23.

To be able to generate the representation 19 of the virtual background 21 and to control the picture elements 35 to display the representation, the background display device 15 has a control device 37 that is connected to a memory 39. A model of the virtual background 21 may in particular be stored in the memory 39 so that the control device may generate the virtual background 21 based on the model. Furthermore, the control device 37 may be configured to project the virtual background 21 onto the background display device 15 and in particular the two-dimensional arrangement of the picture elements 35.

A possible embodiment of the associated camera is schematically shown in FIG. 2. The camera 23 has a camera body 53 to which a lens 59 is fastened. The lens 59 may in particular be configured as an interchangeable lens so that lenses 59 of different kinds may be selectively connected to the camera body 53 and a lens 59 that is optimal for a respective recording may always be selected. The lens 59 has three lens rings 81 by which the respective parameters of the lens 59 may be set. For example, a focusing distance, a focal length, a zoom factor, and/or a diaphragm aperture, in particular an aperture of an iris diaphragm, may be settable or adaptable by rotating a respective one of the lens rings 81. The camera 23 may in particular be configured as a motion picture camera or moving image camera to be able to consecutively generate a sequence of images 73 that may, for example, be played as a film.

To be able to adjust the lens rings 81, a lens ring drive unit 85 is connected to the camera body 53 via a holding rod 87 and comprises a respective lens setting motor 83 for each of the lens rings 81. The lens rings 81 may be rotated by these lens setting motors 83 and adjustments to the lens 59 may be made as a result. In particular, the lens ring drive unit 85 may be remotely actuable so that said lens parameters may be set or changed remotely.

Furthermore, a display device 49 is arranged at the camera body 53 via which information about settings of the camera 23 may be displayed to a user. The display device 49 may in particular be a display. The camera 23 furthermore has an input device 51 which is arranged at the camera body 53 and via which the user may make settings of the camera 23. An exposure time of the camera 23 may in particular be settable at the input device 51, wherein a control device 25 connected to the input device 51 may be configured to control the camera 23 in accordance with the input exposure time. The display device 49 and the input device 51 may in particular be formed by a touch screen via which both information may be displayed to the user and user inputs may be received.

To generate images through light incident through the lens 59, the camera 23 further has an image sensor 1 arranged within the camera body 53. This image sensor 1 may be configured based on, for example, CMOS technology or CCD technology and comprise a plurality of light-sensitive sensor elements that may be arranged in a plurality of rows and columns. Furthermore, the camera 23 has a readout circuit 97 that is configured to read out, process and digitize the signals of the respective sensor elements and to output them to or via a signal output 99. For this purpose, the readout circuit 97 may in particular comprise amplifiers, multiplexers, analog-digital converters, buffer memories, and/or microcontrollers. Ultimately, an image data set B may thus be generated by the camera 23, which corresponds to the image or an image of a field of view of the camera 23, and the image data set B may be output via the signal output 99. To be able to check the field of view of the camera 23 and to align the camera 23 to a respective image section, a viewfinder 79, through which a camera operator may look, is also arranged at the camera body 53.

The background display device 15 further has an interface 103 and the camera 23 has an interface 101 via which information I may in particular be transmittable from the camera 23 to the background display device 15. The control device 37 of the background display device 15 may in particular be configured to control the active illumination apparatus 31 in dependence on information I received from the camera 23.

As already mentioned, each of the plurality of picture elements 35 in the embodiment shown of the background display device 15 comprises a respective light source unit 45, wherein such a light source unit 45 is schematically illustrated in FIG. 3A.

The light source unit 45 has a first light source 44a, a second light source 44b, and a third light source 44c. The first light source 44a is configured to generate a first emission spectrum E1, the second light source 44b is configured to generate a second emission spectrum E2, and the third light source 44c is configured to generate a third emission spectrum E3, wherein the emission spectra E1, E2, and E3 differ from one another. In FIG. 3A, emission spectra E1, E2, and E3 are shown by way of example, wherein the dependence of a brightness H or intensity of the light generated by the respective light source 44a, 44b, and 44c on an emitted wavelength L is shown.

As can be seen from FIG. 3A, the light sources 44a, 44b, and 44c are in particular configured to produce narrow-band emission spectra E1, E2, and E3. The light sources 44a, 44b, and 44c may in particular be respective light-emitting diodes. The first light source 44a may further be configured to emit red light, while the second light source 44b may be configured to emit green light. The third light source 44c may in particular be configured to emit blue light. In this regard, the light source unit 45 may in particular be configured as a so-called red-green-blue (RGB) unit.

Since the light source unit 45 comprises the three light sources 44a, 44b, and 44c having emission spectra E1, E2, and E3 that differ from one another, the control device 37 may be configured to generate a light source unit emission spectrum S by mixing M the emission spectra E1, E2, and E3. For this purpose, the light sources 44a, 44b, and 44c may be individually controllable, in particular by means of the control device 37, to set a respective brightness H and/or intensity of the light sources 44a, 44b, and 44c and thereby to determine a respective contribution of the first emission spectrum E1, the second emission spectrum E2, and the third emission spectrum E3 to the light source unit emission spectrum S.

The first light source 44a and the third light source 44c may in particular further be configured to generate light in a respective end region of the visible light spectrum. The first light source 44a may, for example, be configured to emit red light in an end region of the visible light and the third light source 44c may be configured to emit blue light in an end region of the visible light. The wavelengths L at which the emission spectra E1 and E2 reach their respective maximum may in particular lie in such an end range. Such an emission of light in end regions of the visible light may in particular make it possible to emit light in a large (RGB) color space by means of the light source unit 45. A large color space may thus in particular be available at each picture element 35 of the background display device 15 and almost any desired colors that exist in the representation 19 of the virtual background 21 at an image element assigned to the respective picture element 35 may be displayed.

However, as can be seen from the lower part of FIG. 3A, the light source unit emission spectrum S composed of the narrow-band emission spectra E1, E2, and E3 differs from an emission spectrum N of natural light, which in particular extends continuously, while the light source unit emission spectrum S composed of the emission spectra E1, E2, and E3 has gaps and/or sinks between the respective emission spectra E1, E2, and E3 and abrupt transitions between the respective proportions of the emission spectra E1, E2, and E3 of the light sources 44a, 44b, and 44c. The emission spectrum N of natural light, on the other hand, may in particular be described by a blackbody spectrum P.

However, this difference between the light source unit emission spectrum S and the emission spectrum N of natural light may cause the light emitted by the light source unit 45 to be emitted differently by a real subject 17 that is located in front of or below the background display device 15, in dependence on any spectral reflection properties of the real subject 17, than would be the case under natural light conditions in a real background corresponding to the virtual background 21, for example a landscape. This may in particular also cause colors of the real subject 17, such as an actors clothing, to appear different in the image generated by the camera 23 than on a reflection of natural light by the real subject 17. The correspondingly poor color reproduction quality of such a background display device 15 or of a light element unit 45 may therefore require a post-processing, possibly to be performed sectionally, in the image generated by the camera 23 in order to correct such an unnatural impression of the images generated in the virtual image recording studio 13. Furthermore, for specific recordings, provision may be made to illuminate the real subject 17 in the virtual image recording studio 13, in addition to the background display device 15, also by spotlights that may, however, have an emission spectrum that is optimized for the illumination, that has a high color reproduction quality, and that may in particular replicate natural light. In such mixed light situations, the light reflection by the real subject 17 may in particular even vary sectionally in dependence on whether the respective section is primarily illuminated by the background display device 15 or the spotlight. However, such sectional effects in the image generated by the camera 23 may often not be corrected with a reasonable effort in the course of a post-processing and/or post-production.

To address this problem, the light source unit 45 illustrated by means of FIG. 3B is associated by way of example with two correction light sources 46, wherein the correction light sources 46 are configured to emit a respective correction light emission spectrum K1 or K2. In the embodiment shown, the correction light emission spectra K1 and K2 are different from one another as well as from the emission spectra E1, E2, and E3 of the light sources 44a, 44b, and 44c.

The additional arrangement of correction light sources 46 enables the control device 37, by controlling these correction light sources 46, to adapt the light element unit emission spectrum S to a corrected emission spectrum S1 that is approximated to a predefined or predefinable emission spectrum N and in particular to the emission spectrum N of natural light and/or to the blackbody spectrum P. For this purpose, the correction light emission spectrum K1 may in particular emit light having wavelengths L between the second emission spectrum E2, and the third emission spectrum E3, while the second correction light emission spectrum K2 may be arranged between the first emission spectrum E1 and the second emission spectrum E2 of the light sources 44a and 44b with respect to the emitted wavelengths L.

The correction light sources 46 may also in particular be configured as light-emitting diodes and may accordingly emit narrow-band correction light emission spectra K1 and K2. However, by controlling the correction light sources 46, wherein again in particular an intensity and/or a brightness H of the correction light sources 46 may be set, the corrected emission spectrum S1 may at least be stabilized with respect to the light element unit emission spectrum S and may thereby be approximated to the emission spectrum N of natural light. The sharp increase in the emission spectrum N of natural light at small wavelengths L and the slow levelling toward large wavelengths L may in particular be replicated in the corrected emission spectrum S1 by appropriately controlling the correction light sources 46.

Furthermore, the control device 37 is configured to control the correction light sources 46 such that a wavelength L of a maximum T of the corrected emission spectrum S1 corresponds to a wavelength L of a maximum T of the light element unit emission spectrum S. Thus, the control unit 37 may be configured to approximate the corrected emission spectrum S1 to the emission spectrum N of natural light, but without noticeably changing the color set at the light source unit 45. The large color space producible by the light source unit 45 may thereby in particular also be maintained, wherein, by stabilizing the light element unit emission spectrum S for approximation to the emission spectrum N of natural light, the color reproduction quality of the background display device may, however, be increased.

Furthermore, the control device 37 may also be configured to control the correction light sources 46 such that the maximum T of the corrected emission spectrum S1 corresponds to the maximum T of the light element unit emission spectrum S. Thus, the brightness H of the light element unit emission spectrum S may also remain substantially unchanged by the adaptation so that the representation 19 may be displayed substantially unchanged at the background display device 15 despite the adaptation of the light element unit emission spectra S.

To enable an appropriate control of the correction light sources 46, setting instructions E for the control of the correction light sources 46 in dependence on a control of the light sources 44a, 44b, and 44c may, for example, be stored in a look-up table in the memory 39. For example, a respective setting instruction E for controlling the correction light sources 46 may be stored in such a look-up table for a specific color or a color value set at the light element unit 45 in order to approximate the light element unit emission spectrum S to the emission spectrum N of natural light by appropriately controlling the correction light sources 46.

In the memory 39, in particular parameters and/or calculation instructions may, however, also be stored, wherein the control device 37 may be configured to calculate the light source unit emission spectrum S and/or the corrected emission spectrum S1 based on the calculation instructions and/or parameters. Furthermore, the emission spectra E1, E2, E3 and/or the correction light emission spectra K1 and K2 may, for example, be stored in the memory 39, wherein the control device 37 may be configured to determine the light element unit emission spectrum S and/or the corrected emission spectrum S1 in dependence on respective controls of the light sources 44a, 44b, and 44c and/or the correction light sources 46.

Furthermore, the control device 37 may, for example, be configured to determine the corrected emission spectrum S1 by an approximation method, in particular by determining respective expected corrected emission spectra S1 during specific controls of the correction light sources 46 and determining a deviation from the emission spectrum N of natural light. The respective required setting instructions E for the correction light sources 46 may then be determined as those setting instructions E for which the deviation between the corrected emission spectrum S1 and the emission spectrum N of natural light is minimized.

Provision may in particular be made that each picture element 35 and/or each light source unit 45 of the background display device 15 is associated with at least one respective correction light source 46. Furthermore, provision may be made that one or each light source unit 45 is in particular associated with a plurality of correction light sources 46, in particular two or more than two correction light sources, in order, for example, to further extend the stabilization of the corrected emission spectrum S1 and its approximation to the emission spectrum N of natural light. However, provision may also be made that only some picture elements 35 or light source units 45 are associated with one or more correction light sources 46.

Furthermore, it can be seen from FIG. 3B that the correction light sources 46 may be inserted into the regular grid 55 formed by the picture elements 35. In this regard, existing background display devices 15 may, for example, be retrofitted by attaching such correction light sources 46 and by appropriately adapting a control device 37 in order to achieve an improved color reproduction quality. To facilitate such an insertion, the correction light sources 46 are in particular smaller than the light sources 44a, 44b, and 44c. Thus, a complete restructuring of the background display device 15 and/or the panels 41 is not necessarily required.

As an alternative to approximating the corrected emission spectrum S1 to an emission spectrum N, in particular a predefined emission spectrum N, of natural light, provision is made in the embodiment shown in FIG. 4 that the control device 37 is configured to approximate the corrected emission spectrum S1 to the illumination emission spectrum A generated by the illumination apparatus 105. For this purpose, the background display device 15 has a signal input 111 connected to the illumination apparatus 105 so that the background display device 15 forms a background display system 109 with the illumination apparatus 105. The signal input 111 is configured to receive information I about the illumination emission spectrum A from the illumination apparatus 105 and to transmit it to the control device 37, wherein the information I may, for example, comprise metadata describing the illumination emission spectrum A. Based on this information I, which may also comprise the illumination emission spectrum A itself, for example as a histogram, the control device 37 may then determine the control of the correction light sources 46 in order to approximate the corrected emission spectrum S1 to the illumination emission spectrum A that may be predefined by the illumination apparatus 105 in this regard.

Due to such an approximation of the corrected emission spectrum S1 to the illumination emission spectrum A, it may in particular be achieved that the light of the background display device 15 and the illumination apparatus 105 serving to illuminate the real subject 17 in the virtual image recording studio 13 has approximately matching spectral properties. Spectral shifts of the light reflected by the real subject 17 in dependence on whether the real subject 17 is illuminated by the background display device 15 or the illumination apparatus 105 may thereby be avoided.

The control device 37 may furthermore be configured to approximate or to adjust the corrected emission spectrum S1 to an illumination emission spectrum A that changes during a recording, for which purpose corresponding information I about the illumination emission spectrum A may be provided during the recording. Furthermore, in the embodiment shown, the signal input 111 is connected to a measurement device 115, for example a spectrometer, that is configured to determine the illumination emission spectrum A and to transmit corresponding information I to the signal input 111 so that the control device 37 may make the required adaptation also or only based on this information I.

In general, the illumination apparatus 105 may also be configured to generate light with a color rendering index that is as high as possible and, in this regard, to generate an illumination emission spectrum A that approximates the emission spectrum N of natural light so that in particular the measures explained above for reproducing the emission spectrum N of natural light, in particular a stabilization of the light source unit emission spectrum S, may take place in order to reproduce the illumination emission spectrum A.

### REFERENCE NUMERAL LIST

1 image sensor
10 recording system
11 background display system
13 image recording studio
15 background display device
17 real subject, actor
19 representation
21 virtual background
23 camera
25 control device
31 illumination apparatus
33 LED wall
35 picture element
37 control device
39 memory
41 panel
43 three-dimensional scene
44a first light source
44a second light source
44a third light source
45 light source unit
46 correction light source
49 display device
51 input device
53 camera body
55 grid
59 camera lens, interchangeable lens
79 viewfinder
81 lens ring
83 lens setting motor
85 lens ring drive unit
87 holding rod
91 first object
92 second object
93 third object
94 fourth object
97 readout circuit
99 signal output
101 interface
103 interface
105 illumination apparatus
107 spotlight
109 background display system
111 signal input
113 background display system
115 measurement device
A illumination emission spectrum
B image data set
E1 first emission spectrum
E2 second emission spectrum
E3 third emission spectrum
H brightness
I information
L wavelength
K1, K2 correction light emission spectrum
M mixing
N emission spectrum of natural light
P blackbody spectrum
S light source unit emission spectrum
S1 corrected emission spectrum
T maximum

1. A background display device for a virtual image recording studio that is configured to display, behind or above a real subject, a representation of a virtual background for a recording by an associated camera,
wherein the background display device has at least one panel having a plurality of picture elements in an at least two-dimensional arrangement,
wherein each of the plurality of picture elements has a respective light source unit that comprises a first light source for generating a first emission spectrum, a second light source for generating a second emission spectrum, and a third light source for generating a third emission spectrum,
wherein the background display device has a control device that is configured to individually control the light sources of the light source units and to generate a respective light source unit emission spectrum by mixing the respective first emission spectra, second emission spectra, and third emission spectra,
wherein the panel furthermore has a plurality of correction light sources, and
wherein the control device is configured to adapt the respective light source unit emission spectrum to a corrected emission spectrum, which is approximated to a predefined or predefinable emission spectrum, by controlling the correction light sources.

2. A background display device in accordance with claim 1,
wherein the background display device is configured as an LED wall,
wherein the picture elements are configured as light-emitting diode units and the light sources and the correction light sources are configured as light-emitting diodes.

3. A background display device in accordance with claim 1,
wherein the control device is configured to adapt the light source unit emission spectrum such that a maximum of the corrected emission spectrum corresponds to a maximum of the light source unit emission spectrum or such that a wavelength associated with a maximum of the corrected emission spectrum corresponds to a wavelength associated with a maximum of the light source unit emission spectrum.

4. A background display device in accordance with claim 1,
wherein the first emission spectrum, the second emission spectrum, and the third emission spectrum form narrow-band emission spectra around a respective emission maximum.

5. A background display device in accordance with claim 1,
wherein the control device is configured to approximate the light source unit emission spectra to a blackbody spectrum by controlling the correction light sources.

6. A background display device in accordance with claim 1,
wherein the control device is configured to adapt at least one of intensities or brightnesses of the respective first light source, second light source, and third light source in order to generate a light source unit emission spectrum.

7. A background display device in accordance with claim 1,
wherein the first control device is configured to adapt the light source unit emission spectra by adapting at least one of an intensity or a brightness of the correction light sources.

8. A background display device in accordance with claim 1,
wherein the control device is configured to determine setting instructions for the control of the correction light sources in dependence on the control of the light source units.

9. A background display device in accordance with claim 8,
wherein the control device is connected to a memory and is configured to look up the setting instructions in a look-up table stored in the memory in dependence on the control of the light source units.

10. A background display device in accordance with claim 8,
wherein the control device is configured to determine the light source unit emission spectra in dependence on the control of the respective light sources or to determine the corrected emission spectrum in dependence on the control of the correction light sources.

11. A background display device in accordance with claim 8,
wherein the control device is connected to a memory in which at least one of a group including the first emission spectrum, the second emission spectrum and the third emission spectrum or at least one emission spectrum of the correction light sources is stored.

12. A background display device in accordance with claim 11,
wherein the control device is configured to determine the corrected emission spectrum by superposing the emission spectra of the light sources and the correction light sources.

13. A background display device in accordance with claim 8,
wherein the control device is configured to determine the setting instructions by an approximation method.

14. A background display device in accordance with claim 13,
wherein the control device is configured to compare a corrected emission spectrum to be expected in the case of respective setting instructions with the predefined or predefinable emission spectrum and to determine a deviation between the corrected emission spectrum to be expected and the predefined or predefinable emission spectrum, and wherein the control device is configured to determine the setting instructions by minimizing the deviation.

15. A background display device in accordance with claim 1,
wherein the background display device has a signal input for receiving information about an illumination emission spectrum generated by an illumination apparatus of the virtual image recording studio, wherein the control device is configured to approximate the corrected emission spectrum to the illumination emission spectrum.

16. A background display device in accordance with claim 1,
wherein at least one of the light source units or the light sources are arranged in a regular grid, wherein the correction light sources are arranged between a plurality of the light source units or light sources of the regular grid.

17. A background display device in accordance with claim 1,
wherein the correction light sources are arranged in place of a respective light source of the regular grid.

18. A background display system comprising a background display device in accordance with claim 1 and an illumination apparatus that is configured to generate an illumination emission spectrum for illuminating the real subject in the virtual image recording studio,
wherein the background display device has a signal input for receiving information about the illumination emission spectrum, and
wherein the control device is configured to approximate the corrected emission spectrum to the illumination emission spectrum.

19. A background display system in accordance with claim 18,
wherein the signal input is connected to a measurement device for measuring the illumination emission spectrum, or to the illumination apparatus, the illumination apparatus being configured to transmit the information about the illumination emission spectrum to the signal input.

20. A method of recording a real subject in front of a virtual background in a virtual image recording studio, comprising the steps:
displaying a representation of the virtual background at a background display device in accordance with claim 1;
placing the real subject in front of the background display device; and
recording the real subject in front of the representation of the virtual background by a camera.
